(19) United States
(12) Patent Application Publication
(10) Pub. No.: US 2026/0025827 A1
(43) Pub. Date: Jan. 22, 2026

(54) PHYSICAL DOWNLINK CONTROL CHANNEL (PDCCH) IN DATA REGION

(71) Applicant: Apple Inc., Cupertino, CA (US)

(72) Inventors: Chunhai Yao, Beijing (CN); Chunxuan Ye, San Diego, CA (US); Dawei Zhang, Saratoga, CA (US); Hong He, San Jose, CA (US); Seyed Ali Akbar Fakoorian, San Diego, CA (US); Wei Zeng, Saratoga, CA (US); Weidong Yang, San Diego, CA (US); Oghenekome Oteri, San Diego, CA (US); Sigen Ye, San Diego, CA (US); Jie Cui, San Jose, CA (US)

(21) Appl. No.: 18/996,451

(22) PCT Filed: Aug. 9, 2022
(86) PCT No.: PCT/CN2022/111174

§ 371 Date: Jan. 17, 2025

(51) Int. Cl. H04W 72/23; H04L 5/00; H04W 72/044

(52) U.S. Cl. CPC H04W 72/23; H04L 5/0051; H04W 72/044

(57) ABSTRACT

The disclosure relates to a physical downlink control channel (PDCCH) in a data region. In some embodiments, there is provided a user equipment (UE), comprising: at least one antenna; at least one radio, configured to perform wireless communication using at least one radio access technology; and one or more processor coupled to the at least one radio, wherein the one or more processor are configured to case the UE to: determine configuration information of a time-frequency resource set (TFRS), located in a data region of a subframe, for conveying a PDCCH from a network (NW) device; and monitor for the PDCCH in the TFRS based on the determined configuration information of the TFRS. A first part of the configuration information of the TFRS may indicate Demodulation Reference Signals (DM-RSs) for the PDCCH are front-loaded.

### TECHNICAL FIELD

This application relates generally to wireless communication systems, and particularly to a physical downlink control channel (PDCCH) design for the wireless communication systems.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and IEEE 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a gNode B or gNB).

A RAN provides its communication services with external entities through its connection to a core network (CN). For example, E-UTRAN may utilize an Evolved Packet Core (EPC), while NG-RAN may utilize a 5G Core Network (5GC).

In some cases, the wireless communication system may comprise one or more satellites which may relay signals or act as base stations, such as in a non-terrestrial network (NTN). Compared with a terrestrial network (TN), the NTN is characterized by large propagation delay and satellite movement. New issues arise when the current wireless communication system integrates with the NTN. Some recent studies are directed to evaluating the coverage performance of the NTN and identifying candidate physical radio channels that have coverage issues specific to the NTN.

### SUMMARY

Embodiments relate to user equipment, network devices, methods, program product, and medium for PDCCH design for coverage enhancement.

In some aspects, a user equipment (UE) may comprise: at least one antenna; at least one radio, configured to perform wireless communication using at least one radio access technology; and one or more processor coupled to the at least one radio, wherein the one or more processor are configured to case the UE to: determine configuration information of a control resource set (CORESET) for conveying a physical downlink control channel (PDCCH) from a network (NW) device; and monitor for the PDCCH in the CORESET based on the determined configuration information of the CORESET. A first part of the configuration information of the CORESET may indicate that the CORESET is allowed to span more than three orthogonal frequency division multiplexing (OFDM) symbols in a slot.

In some aspects, a method for wireless communications by a user equipment (UE) may comprise: determining configuration information of a control resource set (CORESET) for conveying a physical downlink control channel (PDCCH) from a network (NW) device, and monitoring for the PDCCH in the CORESET based on the determined configuration information of the CORESET. A first part of the configuration information of the CORESET may indicate that the CORESET is allowed to span more than three orthogonal frequency division multiplexing (OFDM) symbols in a slot.

In some aspects, a network (NW) device may comprise: at least one antenna; at least one radio, configured to perform wireless communication using at least one radio access technology; and one or more processor coupled to the at least one radio, wherein the one or more processor are configured to case the NW device to determine configuration information of a control resource set (CORESET) for conveying a physical downlink control channel (PDCCH) to a user equipment (UE), and transmit the PDCCH in the CORESET based on the determined configuration information of the CORESET. A first part of the configuration information of the CORESET may indicate that the CORESET is allowed to span more than three orthogonal frequency division multiplexing (OFDM) symbols in a slot.

In some aspects, a method for wireless communications by a network (NW) device, may comprise: determining configuration information of a control resource set (CORESET) for conveying a physical downlink control channel (PDCCH) to a user equipment (UE), and transmitting the PDCCH in the CORESET based on the determined configuration information of the CORESET. A first part of the configuration information of the CORESET may indicate that the CORESET is allowed to span more than three orthogonal frequency division multiplexing (OFDM) symbols in a slot.

In some aspects, a user equipment (UE) may comprise: at least one antenna; at least one radio, configured to perform wireless communication using at least one radio access technology; and one or more processor coupled to the at least one radio, wherein the one or more processor are configured to case the UE to: determine configuration information of a time-frequency resource set (TFRS), located in a data region of a subframe, for conveying a physical downlink control channel (PDCCH) from a network (NW) device; and monitor for the PDCCH in the TFRS based on the determined configuration information of the TFRS. A first part of the configuration information of the TFRS may indicate Demodulation Reference Signals (DM-RSs) for the PDCCH are front-loaded.

In some aspects, a method for wireless communications by a user equipment (UE) may comprise: determining configuration information of a time-frequency resource set (TFRS), located in a data region of a subframe, for conveying a physical downlink control channel (PDCCH) from a network (NW) device, and monitoring for the PDCCH in the TFRS based on the determined configuration information of the TFRS. A first part of the configuration information of the TFRS may indicate Demodulation Reference Signals (DM-RSs) for the PDCCH are front-loaded.

In some aspects, a network (NW) device may comprise: at least one antenna; at least one radio, configured to perform wireless communication using at least one radio access technology; and one or more processor coupled to the at least one radio, wherein the one or more processor are configured to case the NW device to: determine configuration information of a time-frequency resource set (TFRS), located in a data region of a subframe, for conveying a physical downlink control channel (PDCCH) from a network (NW) device, and transmit the

PDCCH in the TFRS based on the determined configuration information of the TFRS. A first part of the configuration information of the TFRS may indicate Demodulation Reference Signals (DM-RSs) for the PDCCH are front-loaded.

In some aspects, a method for wireless communications by a network (NW) device, may comprise: determining configuration information of a time-frequency resource set (TFRS), located in a data region of a subframe, for conveying a physical downlink control channel (PDCCH) from a network (NW) device, and transmitting the PDCCH in the TFRS based on the determined configuration information of the TFRS. A first part of the configuration information of the TFRS may indicate Demodulation Reference Signals (DM-RSs) for the PDCCH are front-loaded.

In some aspects, a non-transitory computer readable memory medium may store program instructions executable by one or more processors to cause a user equipment (UE) to perform the method(s) as described above.

In some aspects, a computer program product comprises computer program which, when executed by a processor of a user equipment (UE), causes the UE to perform the method(s) as described above.

In some aspects, a non-transitory computer readable memory medium may store program instructions executable by one or more processors to cause a network (NW) device to perform the method(s) as described above.

In some aspects, a computer program product comprises computer program which, when executed by a processor of a network (NW) device, causes the network (NW) device to perform the method(s) as described above.

The techniques described herein may be implemented in and/or used with a number of different types of devices, including but not limited to cellular base stations, cellular phones, tablet computers, wearable computing devices, portable media players, and any of various other computing devices.

This Summary is intended to provide a brief overview of some of the subject matter described in this document. Accordingly, it will be appreciated that the above-described features are merely examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates an example architecture of a wireless communication system, according to embodiments disclosed herein.

FIG. 2 illustrates a system for performing signaling between a wireless device and a network device, according to embodiments disclosed herein.

FIG. 3 is a diagram showing an example of time-frequency allocation for EPDCCH.

FIG. 4 is a flowchart diagram illustrating an example method for wireless communications based on CORESET extension according to embodiments disclosed herein.

FIGS. 5A-5C illustrates three different examples of REG formation in a CORESET according to embodiments disclose herein.

FIG. 6 is a flowchart diagram illustrating an example method for wireless communications based on CORESET extension according to embodiments disclosed herein.

FIG. 7 is a flowchart diagram illustrating an example method for wireless communications based on PDCCH in data region according to embodiments disclosed herein.

FIGS. 8A-8B illustrates two different examples of REG formation in a TFRS according to embodiments disclose herein.

FIG. 9 is a flowchart diagram illustrating an example method for wireless communications based on PDCCH in data region according to embodiments disclosed herein.

FIG. 10 is a flowchart diagram illustrating an example method for joint channel estimation for a PDCCH in data region according to embodiments disclosed herein.

While the features described herein may be susceptible to various modifications and alternative forms, specific embodiments thereof are shown by way of example in the drawings and are herein described in detail. It should be understood, however, that the drawings and detailed description thereto are not intended to be limiting to the particular form disclosed, but on the contrary, the intention is to cover all modifications, equivalents and alternatives falling within the spirit and scope of the subject matter as defined by the appended claims.

### DETAILED DESCRIPTION

### Acronyms

Various acronyms are used throughout the present disclosure. Definitions of the most prominently used acronyms that may appear throughout the present disclosure are provided below:
3GPP: Third Generation Partnership Project
UE: User Equipment
LTE: Long Term Evolution
NR: New Radio
NTN: Non-Terrestrial Network
TN: Terrestrial Network
IE: Information Element
PDCCH: Physical Downlink Control Channel
PDSCH: Physical Downlink Shared Channel
RRC: Radio Resource Control
CORESET: Control Resource Set
DCI: Downlink Control Information
OFDM: Orthogonal Frequency Division Multiplexing
RE: Resource Element
REG: Resource Element Group
CCE: Control Channel Element
DM-RS: Demodulation Reference Signal

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component. Examples of a UE may include a mobile device, a personal digital assistant (PDA), a tablet computer, a laptop computer, a personal computer, an Internet of Things (IoT) device, or a machine type communications (MTC) device, among other examples, which may be implemented in various objects such as appliances, or vehicles, meters, among other examples.

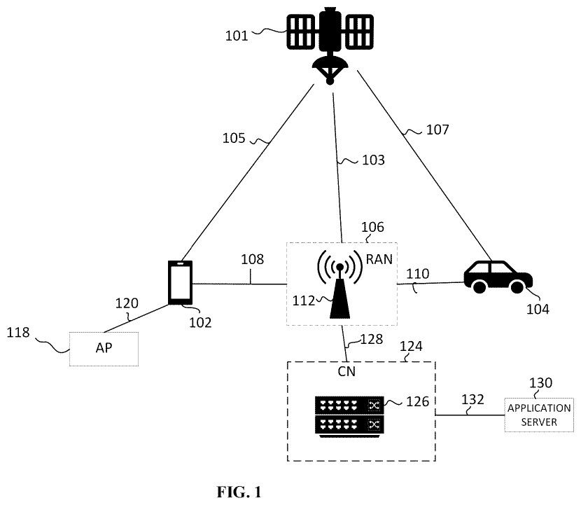

FIG. 1 illustrates an example architecture of a wireless communication system 100, according to embodiments disclosed herein. The following description is provided for an example wireless communication system 100 that operates in conjunction with the LTE system standards and/or 5G or NR system standards as provided by 3GPP technical specifications.

As shown by FIG. 1, the wireless communication system 100 includes a satellite 101, UE 102 and UE 104 (although any number of UEs may be used), and base station 112. In this example, the UE 102 is illustrated as smartphone (e.g., handheld touchscreen mobile computing devices connectable to one or more cellular networks) and the UE 104 is illustrated as a vehicle, but may also comprise any mobile or non-mobile computing device configured for wireless communication.

The UE 102 and UE 104 may be configured to communicatively couple with a RAN 106. In embodiments, the RAN 106 may be NG-RAN, E-UTRAN, etc. The UE 102 and UE 104 utilize connections (or channels) (shown as connection 108 and connection 110, respectively) with the RAN 106, each of which comprises a physical communications interface. The RAN 106 can include one or more base stations, such as base station 112, that enable the connection 108 and connection 110.

In this example, the connection 108 and connection 110 are air interfaces to enable such communicative coupling, and may be consistent with RAT(s) used by the RAN 106, such as, for example, an LTE and/or NR.

In some embodiments, the UE 102 and UE 104 may also directly exchange communication data via a sidelink interface. The UE 104 is shown to be configured to access an access point (shown as AP 118) via connection 120. By way of example, the connection 120 can comprise a local wireless connection, such as a connection consistent with any IEEE 802.11 protocol, wherein the AP 118 may comprise a Wi-Fi® router. In this example, the AP 118 may be connected to another network (for example, the Internet) without going through a CN 124.

In embodiments, the UE 102 and UE 104 can be configured to communicate using orthogonal frequency division multiplexing (OFDM) communication signals with each other or with the base station 112 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers. In some embodiments, all or parts of the base station 112 may be implemented as one or more software entities running on server computers as part of a virtual network.

The RAN 106 is shown to be communicatively coupled to the CN 124. The CN 124 may comprise one or more network elements 126, which are configured to offer various data and telecommunications services to customers/subscribers (e.g., users of UE 102 and UE 104) who are connected to the CN 124 via the RAN 106. The components of the CN 124 may be implemented in one physical device or separate physical devices including components to read and execute instructions from a machine-readable or computer-readable medium (e.g., a non-transitory machine-readable storage medium).

In embodiments, the CN 124 may be an EPC, and the RAN 106 may be connected with the CN 124 via an S1 interface 128. In embodiments, the S1 interface 128 may be split into two parts, an S1 user plane (S1-U) interface, which carries traffic data between the base station 112 and a serving gateway (S-GW), and the S1-MME interface, which is a signaling interface between the base station 112 and mobility management entities (MMEs).

In embodiments, the CN 124 may be a 5GC, and the RAN 106 may be connected with the CN 124 via an NG interface 128. In embodiments, the NG interface 128 may be split into two parts, an NG user plane (NG-U) interface, which carries traffic data between the base station 112 and a user plane function (UPF), and the S1 control plane (NG-C) interface, which is a signaling interface between the base station 112 and access and mobility management functions (AMFs).

Generally, an application server 130 may be an element offering applications that use internet protocol (IP) bearer resources with the CN 124 (e.g., packet switched data services). The application server 130 can also be configured to support one or more communication services (e.g., VoIP sessions, group communication sessions, etc.) for the UE 102 and UE 104 via the CN 124. The application server 130 may communicate with the CN 124 through an IP communications interface 132.

In embodiments, the satellite 101 may communicate with base station 112 and UEs 102 and 104. Satellite 101 may be any suitable type of communication satellite configured to relay communications between different end nodes in a wireless communication system. Satellite 101 may be an example of a space satellite, a balloon, a dirigible, an airplane, a drone, an unmanned aerial vehicle, and/or the like. In some examples, the satellite 101 may be in a geosynchronous or geostationary earth orbit, a low earth orbit or a medium earth orbit. A satellite 101 may be a multi-beam satellite configured to provide service for multiple service beam coverage areas in a predefined geographical service area. The satellite 101 may be any distance away from the surface of the earth.

In embodiments, the satellite 101 may perform the functions of a base station 112, act as a bent-pipe satellite, or may act as a regenerative satellite, or a combination thereof. In other cases, satellite 112 may be an example of a smart satellite, or a satellite with intelligence. For example, a smart satellite may be configured to perform more functions than a regenerative satellite. A bent-pipe satellite may be configured to receive signals from ground stations and transmit those signals to different ground stations. A regenerative satellite may be configured to relay signals like the bent-pipe satellite, but may also use on-board processing to perform other functions. In the case of regenerative satellite, the satellite can be used as base station for the wireless communication.

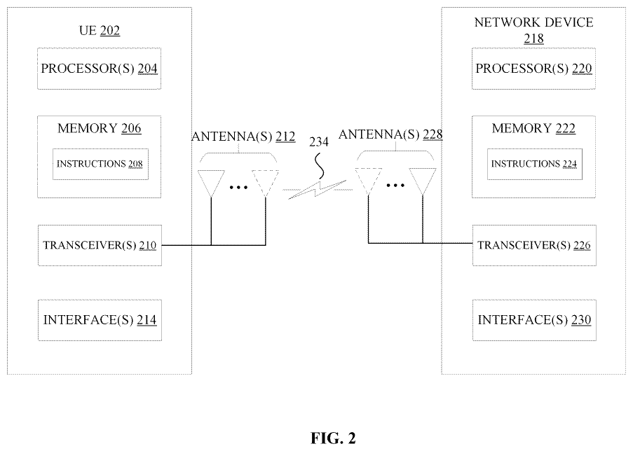

FIG. 2 illustrates a system 200 for performing signaling 234 between a wireless device 202 and a network device 218, according to embodiments disclosed herein. The system 200 may be a portion of a wireless communications system as herein described. The wireless device 202 may be, for example, a UE of a wireless communication system. The network device 218 may be, for example, a base station (e.g., an eNB or a gNB) of a wireless communication system.

The wireless device 202 may include one or more processor(s) 204. The processor(s) 204 may execute instructions such that various operations of the wireless device 202 are performed, as described herein. The processor(s) 204 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 202 may include a memory 206. The memory 206 may be a non-transitory computer-readable storage medium that stores instructions 208 (which may include, for example, the instructions being executed by the processor(s) 204). The instructions 208 may also be referred to as program code or a computer program. The memory 206 may also store data used by, and results computed by, the processor(s) 204.

The wireless device 202 may include one or more transceiver(s) 210 that may include radio frequency (RF) transmitter and/or receiver circuitry that use the antenna(s) 212 of the wireless device 202 to facilitate signaling (e.g., the signaling 234) to and/or from the wireless device 202 with other devices (e.g., the network device 218) according to corresponding RATs.

The wireless device 202 may include one or more antenna(s) 212 (e.g., one, two, four, or more). For embodiments with multiple antenna(s) 212, the wireless device 202 may leverage the spatial diversity of such multiple antenna(s) 212 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 202 may be accomplished according to precoding (or digital beamforming) that is applied at the wireless device 202 that multiplexes the data streams across the antenna(s) 212 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 202 may implement analog beamforming techniques, whereby phases of the signals sent by the antenna(s) 212 are relatively adjusted such that the (joint) transmission of the antenna(s) 212 can be directed (this is sometimes referred to as beam steering).

The wireless device 202 may include one or more interface(s) 214. The interface(s) 214 may be used to provide input to or output from the wireless device 202. For example, a wireless device 202 that is a UE may include interface(s) 214 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 210/antenna(s) 212 already described) that allow for communication between the UE and other devices and may operate according to known protocols (e.g., Wi-Fi®, Bluetooth®, and the like).

The network device 218 may include one or more processor(s) 220. The processor(s) 220 may execute instructions such that various operations of the network device 218 are performed, as described herein. The processor(s) 204 may include one or more baseband processors implemented using, for example, a CPU, a DSP, an ASIC, a controller, an FPGA device, another hardware device, a firmware device, or any combination thereof configured to perform the operations described herein.

The network device 218 may include a memory 222. The memory 222 may be a non-transitory computer-readable storage medium that stores instructions 224 (which may include, for example, the instructions being executed by the processor(s) 220). The instructions 224 may also be referred to as program code or a computer program. The memory 222 may also store data used by, and results computed by, the processor(s) 220.

The network device 218 may include one or more transceiver(s) 226 that may include RF transmitter and/or receiver circuitry that use the antenna(s) 228 of the network device 218 to facilitate signaling (e.g., the signaling 234) to and/or from the network device 218 with other devices (e.g., the wireless device 202) according to corresponding RATs.

The network device 218 may include one or more antenna(s) 228 (e.g., one, two, four, or more). In embodiments having multiple antenna(s) 228, the network device 218 may perform MIMO, digital beamforming, analog beamforming, beam steering, etc., as has been described.

The network device 218 may include one or more interface(s) 230. The interface(s) 230 may be used to provide input to or output from the network device 218. For example, a network device 218 that is a base station may include interface(s) 230 made up of transmitters, receivers, and other circuitry (e.g., other than the transceiver(s) 226/antenna(s) 228 already described) that enables the base station to communicate with other equipment in a core network, and/or that enables the base station to communicate with external networks, computers, databases, and the like for purposes of operations, administration, and maintenance of the base station or other equipment operably connected thereto.

### PDCCH Coverage Enhancement

In 3GPP Release 18 (Rel-18) NR, NTN work item description has an objective of coverage enhancement. The Rel-18 NTN objectives are focused on the applicability of the solutions developed by general NR coverage enhancement to NTN, and identifying potential issues and enhancements if necessary, considering the NTN characteristics including large propagation delay and satellite movement. The work needs to cover the use case of voice and low-data rate services using commercial smartphones with more realistic assumptions on antenna gains instead of 0 dBi currently assumed for link budget analysis for non-terrestrial networks. The evaluation should also take into account any related regulatory requirements, e.g., ITU limitation of power flux density.

One recent study in this aspect are focused on evaluating the coverage performance of NTNs and identifying the candidate physical radio channels that have coverage issues specific to NTN with the following target services into account: VOIP and low-data rate services for commercial handset terminals.

For compatibility with mixed pairing of 1610-1618.725 MHz uplink (UL) (L-band) and 2483.5-2500 MHZ downlink (DL) (S-band) that has been used in many terrestrial networks (TN), NR NTN would likely use the same mixed pairing. For S-band 2483.5-2500 MHz DL for mobile-satellite service, the power flux density (PFD) limitations for different kinds of space stations can be calculated based on some ITU radio regulations. For example, in the S band, a geostationary orbit (GSO) space station may have a PFD limit P of −146 dB (W/m²) in 4 kHz band and −128 dB (W/m²) in 1 MHz band, with the angle of arrival δ satisfies 0°≤δ≤5°. For other angles of arrival, the PFD limit can be calculated as P+r(δ−5), for 5°<δ≤25°, or P+20r, for 25°≤δ≤90°, wherein r=0.5. Also in the S band, a non-GSO space station may have a PFD limit P of −144 dB (W/m²) in 4 kHz band and −126 dB (W/m²) in 1 MHz band, with 0°≤δ≤5°. Depending on regions, the PFD limit may equal to P of −142.5 dB (W/m²) in 4 kHz band and −124.5 dB (W/m²) in 1 MHz band with 0°≤δ≤5°. For other angles of arrival, the PFD limit can be calculated as P+r(δ−5), for 5°<δ≤25°, or P+20r, for 25°≤δ≤90°, wherein r=0.65.

The calculation results of PFD limitations on S-band shows that the downlink transmission power (or Equivalent isotropic radiated power (EIRP)) in the S-band may not be enough to cover the whole cell of space station satellites either GSO or non-GSO. Therefore, the downlink channel from the satellites to UEs on the earth may need coverage enhancement.

Among all the physical downlink channels, the present disclosure focuses on the coverage enhancement for physical downlink control channels (PDCCHs) as it is recognized by the inventors of the present disclosure that, the coverage issues may be more severe for the PDCCHs as compared to other physical downlink channels such as physical downlink shared channels (PDSCHs) because of the short time resource allocated to PDCCHs.

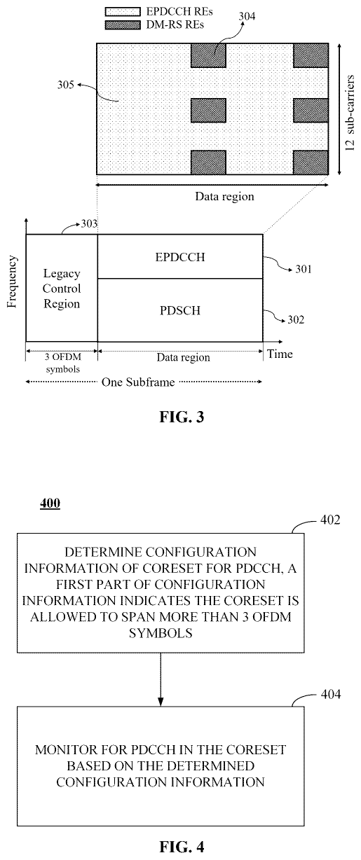

PDCCHs are control channels for transmitting downlink control information (DCI) to instruct the UE to receive PDSCHs carrying downlink data correctly and uplink grant to allocate uplink resources for physical uplink shared channels (PUSCHs). In LTE or LTE advanced protocols, normally, PDCCH is transmitted via a legacy downlink control region of a subframe. To increase control channel capacity in support of busy cells, an enhanced PDCCH (EPDCCH) was introduced in 3GPP Rel-11. The concept of EPDCCH is to use legacy data resources (such as resources for PDSCH carrying downlink data) for control information transmission. FIG. 3 is a diagram showing an example of time-frequency allocation for EPDCCH. As shown in FIG. 3, An EPDCCH 301 shares the time resource for a PDSCH 302, that is, the EPDCCH is frequency-multiplexed with the PDSCH. The EPDCCH 301 can be located on the same carries with a legacy control region 303 that usually occupies the beginning up to 3 OFDM symbols of a slot of a subframe. An EPDCCH is carried via a number of consecutive enhanced control channel elements (eCCEs). The number is referred to as an aggregation level which could be a value of 1, 2, 4, 8, 16 or 32. Each eCCE has 4 enhanced resource element groups (eREGs) or 8 eREGs. Each eREG has 9 resource elements (REs), and thus each physical resource block (PRB) pair has 16 eREGs. There are two different ways of mapping eREGs to REs, i.e., a “distributed” way and a “localized” way. In the localized mapping (or transmission type), REs in the same eREG would be clustered in the same frequency resource block. While in the distributed way (or transmission type), REs in the same eREG is scattered in much random fashion. Some additional REs are allocated to Demodulation Reference Signals (DM-RSs), which can be referred to as DM-RS REs. As shown in FIG. 3, DM-RS REs 304 are dispersed (or distributed) in the EPDCCH REs 305 in fixed locations. They do not occupy any separate and whole OFDM symbols in the time domain.

In NR protocols, PDCCH is transmitted via a control resource set (CORESET) of a slot. The CORESET is equipment to the legacy control region in an LTE/LTE advanced subframe except that the CORESET is allocated on a bandwidth part (BWP) basis in the frequency domain while the control region of LTE/LTE advanced occupies the total system bandwidth. In addition, the CORESET is allocated on a slot basis rather than a subframe basis in LTE/LTE advanced. NR PDCCH supports aggregation levels of 1, 2, 4, 8 and 16, which indicates how many consecutive CCEs a NR PDCCH is allowed to use. Each CCE is composed of 6 REGs. The CCE-to-REG mapping can be interleaved or non-interleaved. Each REG has 12 REs, among which 9 REs are used to carry DCI and 3 REs are used to carry PDCCH DM-RS. The DM-RS pattern is designed such that there is 1 DM-RS RE in every 4 REs. Each RE has a frequency dimension of one OFDM symbol and a time domain of one sub-carrier, and is the smallest unit for time-frequency resource allocation. 2, 3 or 6 REGs are bundled together to form a REG bundle where a same precoding is applied to the REGs therein. The duration of

CORESET can be 1, 2 or 3 OFDM symbols. In the frequency domain, the CORESET includes one or more units of 6 PRBs.

To enhance the coverage of PDCCH when NR is integrated with NTN, the inventors of the present disclosure contemplate increasing the aggregation level of PDCCH from 16 to a higher number. However, if the duration of CORESET is still limited to 3 symbols as in current 3GPP specifications, then the number of PRBs to support an aggregation level of more than 16 will be too large. Therefore, some first aspects of the present disclosure propose extending the OFDM symbol duration of CORESET to be more than 3 OFDM symbols. In these aspects, configurations of CORESET, including configurations of related search space, will be modified. Some second aspects of the present disclosure propose making use of time-frequency resources for data transmissions (i.e., data region) to transmit PDCCH. That is, the PDCCH can be conveyed outside the CORESET and thus limitation on the PDCCH by the duration of the CORESET is alleviated. In these aspects, since the proposed PDCCH is quite different from that conveyed in the CORESET, configuration of the resource set for the new PDCCH are designed in detail.

It should be recognized that although the coverage issues arise with the NTN, and the solutions, techniques and embodiments of the present disclosure can be applied to the NTN, they are not limited to the NTN, but can be applied to various wireless networks that require coverage enhancement for the PDCCH.

### Coreset Extension

FIG. 4 is a flowchart diagram illustrating an example method 400 for wireless communications based on CORESET extension according to embodiments disclosed herein. Aspects of the method 400 may be implemented by a UE such as a UE 102 or UE 104 illustrated in FIG. 1 or UE 202 illustrated in FIG. 2 herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Method 400 begins, at block 402, with the UE determining configuration information of a CORESET for conveying a PDCCH from a NW device. A first part of the configuration information of the CORESET indicates that the CORESET is allowed to span more than three OFDM symbols in a slot.

At block 404, method 400 continues with the UE monitoring for the PDCCH in the CORESET based on the determined configuration information of the CORESET. The configuration information of the CORESET describes how the CORESET is configured for carrying the PDCCH. With the configuration information of the CORESET for the PDCCH determined, the UE may know where and how to blindly detect the PDCCH.

In some embodiments, the configuration information of the CORESET may be at least partially set statically or semi-statically by a network specification that is known to both parties of the wireless communications, i.e., the UE and the network device, in advance. In this case, the UE and the network device may individually determine the configuration information of the CORESET based on the network specification. Alternatively or additionally, in some embodiments, the configuration information of the CORESET may be at least partially set dynamically by the network device. In this case, the network device may determine the configuration information of the CORESET and transmit the determined configuration information of the CORESET to the UE so that the UE can know how to detect the potential PDCCH. The network device may configure the CORESET based on the determined configuration information of the CORESET to convey the PDCCH. Correspondently, the UE may blindly detect the PDCCH based on the determine configuration information of the CORESET.

In some embodiments, prior to block 402, method 400 may further comprise the UE receiving at least the first part of the configuration information of the CORESET from the NW device. The first part of the configuration information may be transmitted from the NW device to the UE via at least one of a master information block (MIB), a system information block (SIB), radio resource control (RRC) signaling, or UE specific signaling from the NW device.

In some embodiment, the maximum number of OFDM symbols the CORESET is allowed to occupy as indicated by the first part of the configuration information of the CORESET may be not greater than a number of OFDM symbols that constitute a slot. In other words, a CORSET for transmitting PDCCH may not extend across slots. Per existing 3GPP NR specifications, a slot is composed of 14 OFDM symbols and thus the CORESET can occupy up to 14 OFDM symbols.

In some embodiments, the indication that the CORESET is allowed to span more than three OFDM symbols means that the CORESET may occupy more than three consecutive OFDM symbols, so that it is compatible with existing 3GPP NR specifications where the CORESET are generally allocated with 1 to 3 consecutive OFDM symbols. But in some other embodiments, the first part of the configuration information of the CORESET may indicates that the CORESET is allowed to span more than three OFDM symbols no matter they are consecutive or non-consecutive.

The first part of the configuration information may indicate that the CORESET is allowed to span more than 3 OFDM symbols in various ways. In some embodiments, the first part of the configuration information of the CORESET may include a duration of the CORESET that is allowed to be greater than three OFDM symbols. For example, the duration of the CORESET may be a “duration” field in ControlResourceSet Information Element (IE) of a RRC signaling as defined in existing 3GPP NR specifications. In some examples, the “duration” field can be either 6 consecutive OFDM symbols or 12 consecutive OFDM symbols. In some other examples, the “duration” filed can be configured as any number of consecutive OFDM symbols between 1 and 14. Since the maximum duration is 14 OFDM symbols, which is greater than 3 OFDM symbols, thus the “duration” field configured as such also indicates that the CORESET is allowed to span more than 3 OFDM symbols.

In some embodiments, the first part of the configuration information of the CORESET may include configuration information for a search space for the PDCCH. The CORESET defines time-frequency resources for carrying PDCCH and a search space defines information about PDCCH candidates, in particular about when and where a UE monitors for or detects a PDCCH candidate based on which aggregation level. The configuration information for the search space for the PDCCH may indicate a number of OFDM symbols to be monitored for the PDCCH in a slot is greater than three. For example, the configuration information for the PDCCH may be a “monitoringSymbolsWithinSlot” field in SearchSpace IE of a RRC signaling as defined in existing 3GPP NR specifications. In some examples, the “monitoringSymbolsWithinSlot” field comprises one or more starting symbol indicators and monitoring lengths corresponding to the respective starting symbol indicators to indicate the number of OFDM symbols to be monitored for the PDCCH. In case of extended CORESET, the monitoring length is greater than 3 OFDM symbols. In some examples, the “monitoringSymbolsWithinSlot” field comprises a bitmap to indicate the number of OFDM symbols to be monitored for the PDCCH. The first bit of the bitmap corresponds to the first OFDM symbol of a slot where the CORESET associated with the search space is located and the following bits correspond to the following OFDM symbols of the slot. In this way, using the configuration information for the search space such as the “monitoringSymbolsWithinSlot” field, it is also possible to indicate whether the CORESET is allowed to span more than 3 OFDM symbols.

In some embodiments, in addition to the first part, the configuration information of the CORESET may further comprise an aggregation level for the PDCCH that is more than sixteen. Like in LTE/LTE advanced or NR, in the embodiments of the present disclosure, the aggregation level indicates how many CCEs are used to carry one single PDCCH. A network specification or the NW device may define a set of aggregation levels that a PDCCH is allowed to use and notify the UE of the set of aggregation levels. Which aggregation level will be used for a specific PDCCH can be determined based on the actual radio conditions in real time. Compared to existing 3GPP NR specifications, the aggregation level according to embodiments as disclosed herein may be increased as a result of the extension of the CORESET to be more than 3 OFDM symbols. For example, the aggregation level for the PDCCH may be indicated in an “nrofCandidates” field in SearchSpace IE of a RRC signaling as defined in existing 3GPP NR specifications. For both common search spaces (CSSs) and UE specific search spaces (USSs), the “nrofCandidates” field may be extended to aggregation levels that is greater than sixteen, such as “aggregationLevel32”, “aggregationLevel64” and “aggregationLevel128”, etc.

In some embodiments, to specifically describe the organization of resource elements (REs) of the CORESET for carrying the PDCCH, the configuration information of the CORESET may further comprise frame structure of the CORESET. The frame structure of the CORESET may indicate REG formation that refers to grouping REs into REGs and CCE-to-REG mapping that refers to mapping one or more CCEs for carrying the PDCCH to REGs.

For the REG formation, it may be restricted that all REs in a REG are on one slot (e.g. 14 consecutive OFDM symbols) within a physical resource block (PRB, e.g. 12 subcarriers). Conventionally as in existing 3GPP NR specifications, a REG is composed of 12 REs on one OFDM symbol within one PRB. But as the duration of the CORESET is extended according to aspects of the present disclosure, the REG formation is not limited to the conventional way, but may be more flexible.

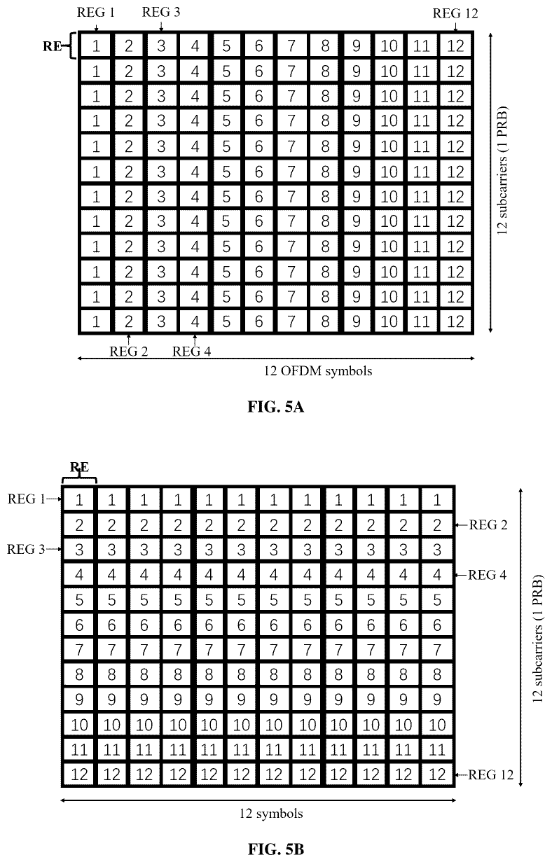

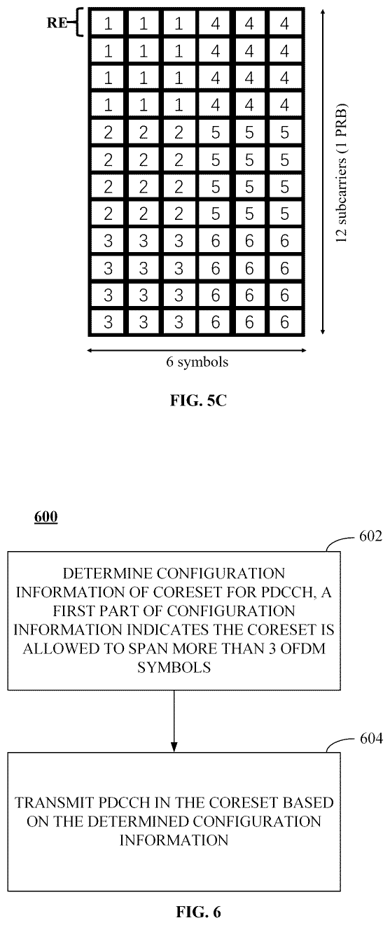

FIGS. 5A-5C illustrates three different examples of REG formation in a CORESET according to embodiments disclose herein. In some embodiments, the REGs are formed such that all REs in a REG are on one OFDM symbol within a PRB in the CORESET (referred to as “localized REG formation”). As shown in FIG. 5A, each REG (REG 1 to REG 12) occupies a column of the resource grid, which means that all the REs in the REG are within one OFDM symbol. In some embodiments, the REGs are formed such that all REs in a REG are distributed over different OFDM symbols within a PRB in the CORESET (referred to as “distributed REG formation”). As shown in FIG. 5B, each REG (REG 1 to REG 12) occupies a row of the resource grid, which means that all the REs in the REG are on different OFDM symbols with no overlapping in the time domain. Alternatively, as shown in FIG. 5C, one REG may be distributed over 3 OFDM symbols with 4 REs per OFDM symbol. It should be recognized that FIGS. 5A-5C are merely for examples of REG formation, and the number of REs in a REG and the duration of the CORESET are not specifically limited.

In some embodiments, on a single CORESET level, all the REGs may be uniformly formed from the same number of REs. Further, in some embodiments, all the REGs may be formed from REs in the same way of localized REG formation or distributed REG formation. In other embodiments, REGs in a CORESET may have different number of REs and/or may not be formed in the same localized or distributed way.

As an example, a REG may be composed of 12 REs among which 9 REs are for carrying DCI and 3 REs are used for PDCCH DM-RS. The PDCCH DM-RS pattern may be 1 DM-RS RE in every 4 REs.

For the CCE-to-REG mapping, a CCE may be composed of various number of REGs based on a localized mapping or a distributed mapping in the frequency domain. Localized mapping means that all REGs of a CCE are located in a slot over a single PRB in the CORESET. For example, a CCE #1 is composed of REG {1, 2, 3, . . . , 6} in the first PRB. Distributed mapping means that REs of a CCE are located in a slot over different PRBs in the CORESET. For example, a CCE #1 is composed of REG {1, 5, 9} from the first PRB and REG {3, 7, 11} from the second PRB. As an example, each CCE may be composed of 6 REGs with each REG comprising 12 REs and thus each CCE may be composed of 72 REs. In some embodiments, on a single CORESET level, all of the CCE may be uniformly composed of the same number of REGs. Further, in some embodiments, all the REGs may have the same localized or distributed CCE-to-REG mapping. In other embodiments, CCEs of a CORESET may have different number of REGs and/or may not be mapped to REGs in the same localized or distributed way.

A number of REGs may be selected to be bundled together so that the NW device may apply the same precoding to the bundled REGs and the UE may assume that the NW device has applied the same precoding to the bundled REGs. The number of REGs being bundled is called REG bundling size. REG bundling size may be fixed or may be varied according to the duration of the associated CORESET. In some embodiments, the REG bundling size may be 2, or may be greater than 3, e.g., 6. In some embodiments, the REG bundling size may be greater than 6. In this case, the CCE size (number of REGs in a CCE) would be increased accordingly.

The set of REGs being bundled together is called a REG bundle. In some embodiments, a REG bundle may be composed of more than two contiguous REGs in a PRB. Contiguous REGs means that the REGs are contiguous in frequency and/or time domain. For example, REG bundle #1 may be composed of REG {1, 2, 3, . . . , 6} in the PRB as shown in FIGS. 5A & 5B and REG bundle #2 may be composed of REG {7, 8, 9, . . . , 12} in the PRB as shown in FIGS. 5A & 5B. If the REG bundling size is greater than 3, this REG bundle pattern would be quite different from existing NR specifications because existing NR specifications support a maximum of 3 REGs in a PRB due to the CORESET duration limitation and thus cannot support a REG bundle size greater than 3. In some embodiments, a REG bundle may be composed of interlaced REGs in a PRB. Interlaced REGs means that the REGs are not contiguous in frequency or time domain. For example, REG bundle #1 may be composed of REG {1, 3, 5, . . . , 11} in the PRB as shown in FIGS. 5A & 5B and REG bundle #2 may be composed of REG {2, 4, 6, . . . , 12} in the PRB as shown in FIGS. 5A & 5B. This REG bundle pattern is quite special because existing NR specifications do not support a REG bundle being composed of REGs that are not contiguous in the time or frequency domain.

In some embodiments, it may be further defined or configured that all the REGs or REG bundles within the same PRB of the CORESET use the same precoding. That is, the actual REG bundle size can be equal to the number of REGs in a PRB of the CORESET.

FIG. 6 is a flowchart diagram illustrating an example method 600 for wireless communications based on CORESET extension according to embodiments disclosed herein. Aspects of the method 600 may be implemented by a network device such as satellite 101, or base station 112 illustrated in FIG. 1 or network device 218 illustrated in FIG. 2 herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In wireless communications between a UE and a network device, method 400 performed at the UE side and method 600 performed at the network device side may be implemented in a collaborative way. As features of method 400 have been described in details, features of method 600 that can be shared by both the network side and the UE side can be referred to with a reference to the description of method 400. Below only the features specific to the network side will be discussed.

Method 600 begins, at block 602, with the network device determining configuration information of a CORESET for conveying a PDCCH to a UE. A first part of the configuration information of the CORESET indicates that the CORESET is allowed to span more than three OFDM symbols in a slot. The configuration information of the CORESET corresponds to that described at block 402 of method 400, and thus the features thereof are omitted here.

At block 604, method 600 continues with the network device transmitting the PDCCH in the CORESET based on the determined configuration information of the CORESET. The configuration information of the CORESET describes how the CORESET is configured for carrying the PDCCH. Therefore, upon determination of the configuration information of the CORESET, the NW device would know how to configure the CORESET and then load and transmit the PDCCH in the configured CORESET.

In some embodiments, prior to block 604, method 600 may further comprise the NW device transmitting at least the first part of the configuration information of the CORESET to the UE. The first part of the configuration information may be transmitted via at least one of a MIB, a SIB, RRC signaling, or UE specific signaling from the NW device.

### PDCCH in Data Region

FIG. 7 is a flowchart diagram illustrating an example method 700 for wireless communications based on PDCCH in data region according to embodiments disclosed herein. Aspects of the method 700 may be implemented by a UE such as a UE 102 or UE 104 illustrated in FIG. 1 or UE 202 illustrated in FIG. 2 herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

Method 700 begins, at block 702, with the UE determining configuration information of a time-frequency resource set (TFRS) for conveying a PDCCH from a NW device. The TFRS is located in a data region of a subframe. A first part of the configuration information of the TFRS indicates DM-RSs for the PDCCH are front-loaded.

In some embodiments, the configuration information of the TFRS may be at least partially set statically or semi-statically by a network specification that is known to both parties of the wireless communications, i.e., the UE and the network device, in advance. In this case, the UE and the network device may individually determine the configuration information of the TFRS based on the network specification. Alternatively or additionally, in some embodiments, the configuration information of the TFRS may be at least partially set dynamically by the network device. In this case, the network device may determine the configuration information of the TFRS and transmit the determined configuration information of the TFRS to the UE so that the UE can know how to detect the potential PDCCH. The network device may configure the TFRS based on the determined configuration information of the TFRS to convey the PDCCH. Correspondently, the UE may blindly detect the PDCCH based on the determine configuration information of the TFRS.

In some embodiments, the first part of the configuration information of the TFRS that indicates the front-loaded DM-RSs for the PDCCH is predefined by a network specification. In some embodiments, the front-loaded DM-RSs may be located in the first several OFDM symbols of the TFRS allocated to the PDCCH. In some other embodiments, the front-loaded DM-RSs may be located in fixed OFDM symbols with respect to a slot for carrying the PDCCH, for example in the first several OFDM symbols after a CORESET for carrying other PDCCHs in a slot where the TFRS is located. Unlike conventional PDCCH (including EPDCCH) which has REs for DM-RSs distributed in the REs for carrying DCI, in these embodiments of the present disclosure, REs for front-loaded DM-RSs are separate from REs for carrying DCI.

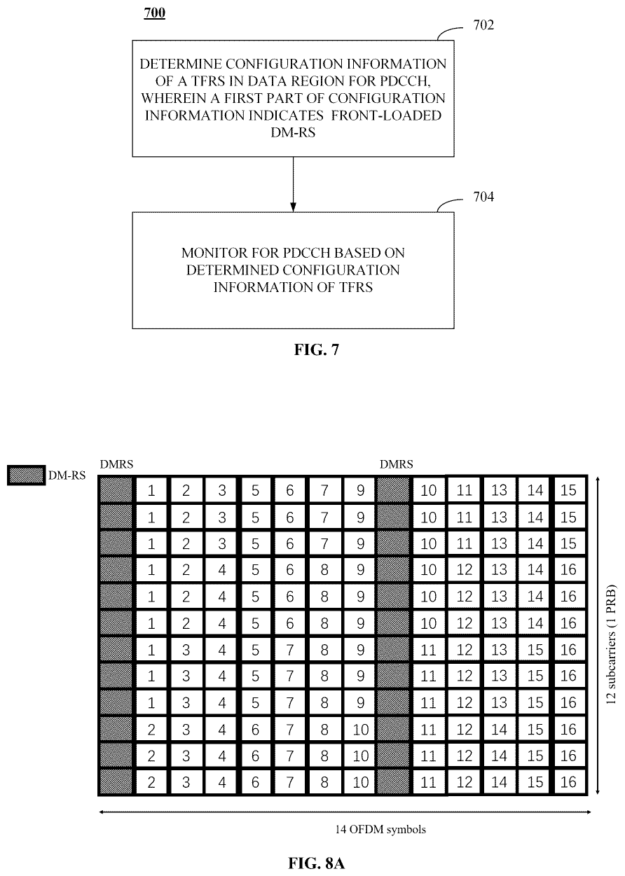

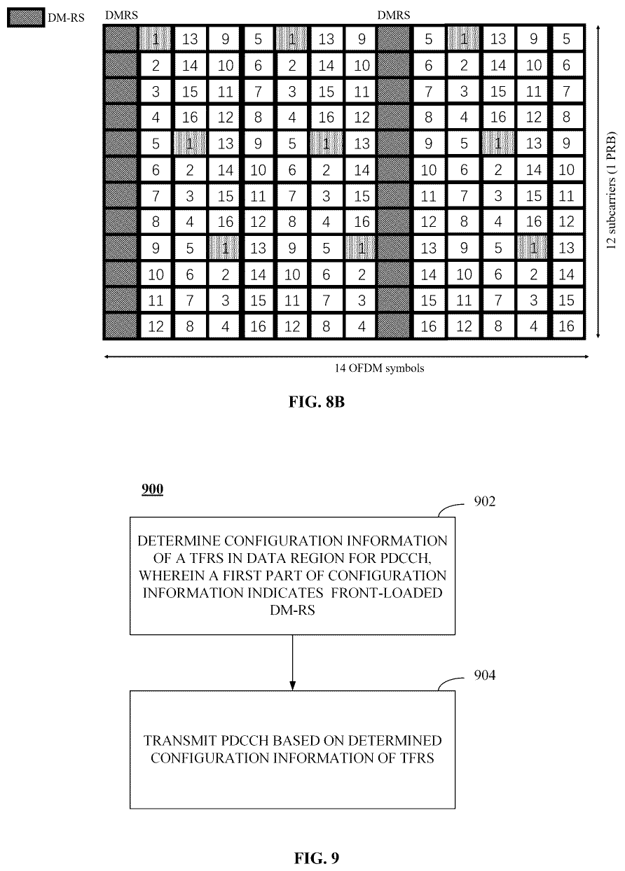

In addition to the front-loaded DM-RSs, there may be additional DM-RSs in subsequent OFDM symbols on a slot of the TFRS, depending on specific network configuration. For example, as shown in FIGS. 8A and 8B, the first DM-RS column refers to the front-loaded DM-RSs and the second DM-RS column refers to the additional DM-RSs. Both type 1 and type 2 DM-RS pattern, like those for a PDSCH, may be supported by configuration.

As a PDSCH may also be in the data region of the subframe, in some embodiments, the PDCCH may be at least partially frequency multiplexed with the PDSCH. In some embodiments, the PDCCH may at least partially time-multiplexed with the PDSCH. In either way, the design could be beneficial for a network with the requirement for coverage enhancement for PDCCH and providing a low data rate service.

At block 704, method 700 continues with the UE monitoring for the PDCCH in the TFRS based on the determined configuration information of the TFRS. The configuration information of the TFRS describes how the TFRS is configured for carrying the PDCCH. With the configuration information of the TFRS for the PDCCH determined, the UE may know where and how to blindly detect the PDCCH.

In some embodiments, prior to block 702, method 700 may further comprise the UE receiving at least part of the configuration information of the TFRS from the NW device. The configuration information of the TFRS may be transmitted from the NW device to the UE via at least one of a MIB, a SIB, RRC signaling, or UE specific signaling from the NW device.

In some embodiments, the configuration information of the TFRS further comprises a combination of a slot offset, time domain resource allocation (TDRA) information, and frequency domain resource allocation (FDRA) information for the PDCCH, which specifies the time-frequency locations of the TFRS. The slot offset indicates a time gap between the TFRS slot. For example, the reference slot can be the first slot in SFN 0, or the first slot in a configured reference SFN number. The TDRA information indicates a starting symbol and symbol duration (or length of consecutive symbols occupied by the TFRS) in a slot for the TFRS. In some embodiments, a dedicated TDRA table may be configured for the TFRS for the PDCCH. In other embodiments, a TDRA table for a PDSCH may be reused as a TDRA table for the PDCCH. In either way, each entry of the TDRA table contains a specific starting symbol and symbol duration. The TDRA information contained in the configuration information of the TFRS indicates a table entry of the TDRA table. Then the UE may look up in the TDRA table and obtain the starting symbol and symbol duration. The FDRA information indicates the frequency locations of the TFRS. In some embodiments, the FDRA information directly comprises a start PRB index and the number of PRBs occupied by the TFRS. In some other embodiments, a number (e.g., 6) of PRBs form a PRB group, and the FDRA information comprises a start PRB group index and the number of PRB groups occupied by the TFRS. In some other embodiments, the FDRA information comprises a bitmap to indicate the allocated PRBs or PRB groups for the TFRS.

In some embodiments, the configuration information of the TFRS further comprises a repetition number indicating a number of times the time domain resource allocation (TDRA) for the PDCCH is to be repeated. The repetition number can be like 1, 2, 4 or 8, but is not limited to these numbers. The repetition number may be indicated by the TDRA table as discussed above, e.g., as an optional field in a TDRA table entry. In some embodiments, the configuration information of the TFRS may further comprises a repetition type associated with the repetition number indicating how the TDRA is to be repeated. The repetition type can be e.g., an intra-slot repetition, or an inter-slot repetition. In case of inter-slot repetition, or intra-slot repetition cross over multiple slots, DM-RS bundling can be applied, as will be described in detail later. For example, if the TDRA indicates that the TFRS for the PDCCH is located from the third OFDM symbol and lasts for two OFDM symbols, the repetition is 2, and the repetition type is inter-slot, it means that the same TDRA applies to consecutive two slots allocated to the TFRS.

In some embodiments, the configuration information of the TFRS further comprises a periodicity indicating which slot shall be used for transmitting the PDCCH. In some embodiments, a bitmap may be used to indicate the periodicity. For example, a bitmap {10110} means that the first, third and fourth slot in every 5 slots shall be used for the PDCCH. In some embodiments, the periodicity may simply be indicated via a single value. For example, the value may be indicated that the periodicity is every 5 slots.

In some embodiments, to specifically describe the organization of resource elements (REs) of the TFRS for carrying the PDCCH, the configuration information of the TFRS may further comprise frame structure of the TFRS. The frame structure of the TFRS may indicate REG formation that refers to grouping REs into REGs and CCE-to-REG mapping that refers to mapping one or more CCEs for carrying the PDCCH to REGs.

Compared with existing 3GPP NR specifications, REG formation according to aspects of the present disclosure can be more flexible. As the DM-RSs are front-loaded or additional type, the REGs are only composed of REs for carrying DCI, without REs for DM-RS. As an example, a REG may be composed of 9 REs and as such, one PRB over one slot may have a maximum of 16 REGs. Actual number of REGs in one PRB over one slot depends on the TDRA, specifically on the symbol duration, as discussed above. The indexes for REGs may be continuously increased as PRB indexes increase.

FIGS. 8A-8B illustrates two different examples of REG formation in a TFRS according to embodiments disclose herein. In some embodiments, the REGs are formed such that at least one of the REGs is formed from REs that are located on a slot within a PRB in the time-frequency resource set in a localized way. It means that at least one REG is formed from several contiguous REs. As shown in FIG. 8A where each REG comprises 9 REs, the first REG (grids that are labeled with the number “1”) is composed of the first 9 consecutive REs in a frequency-first direction and the second REG (grids that are labeled with the number “1”) is composed of the next 9 consecutive REs. In this way, REs of a REG are on one or two neighboring OFDM symbols. In some embodiments, the REGs are formed such that at least one of the REGs is formed from REs that are located on a slot within a PRB in the time-frequency resource set in a distributed way. It means that at least one REG is formed from several non-contiguous REs. As shown in FIG. 8B, the first REG (grids that are labeled with the number “1”) is composed of REs that are separated by 15 REs from each other. It should be recognized that FIGS. 8A-8B are merely for examples of REG formation, and the number of REs in a REG and the symbol duration are not specifically limited.

In some embodiments, on a single TFRS level, all the REGs may be uniformly formed from the same number of REs. Further, in some embodiments, all the REGs may be formed from REs in the same way of localized REG formation or distributed REG formation. In other embodiments, REGs in a TFRS may have different number of REs and/or may not be formed in the same localized or distributed way.

For the CCE-to-REG mapping, a CCE may be composed of various number of REGs based on a localized mapping or a distributed mapping in the frequency domain. Localized mapping means that all REGs of a CCE are located in a slot over a single PRB in the TFRS. For example, a CCE #1 is composed of REG {1, 2, 3, . . . , 6} in the first PRB. Distributed mapping means that REs of a CCE are located in a slot over different PRBs in the TFRS. For example, a CCE #1 is composed of REG {1, 5, 9} from the first PRB and REG {3, 7, 11} from the second PRB. As an example, each CCE may be composed of 6 REGs with each REG comprising 12 REs and thus each CCE may be composed of 72 REs.

In some embodiments, on a single TFRS level, all of the CCE may be uniformly composed of the same number of REGs. Further, in some embodiments, all the REGs may have the same localized or distributed CCE-to-REG mapping. In other embodiments, CCEs of a TFRS may have different number of REGs and/or may not be mapped to REGs in the same localized or distributed way.

A number of REGs may be selected to be bundled together so that the NW device may apply the same precoding to the bundled REGs and the UE may assume that the NW device has applied the same precoding to the bundled REGs. The number of REGs being bundled is called REG bundling size. REG bundling size may be fixed or may be varied according to the symbol duration of the associated TFRS. In some embodiments, the REG bundling size may be 2, or may be greater than 3, e.g., 6. In some embodiments, the REG bundling size may be greater than 6. In this case, the CCE size (number of REGs in a CCE) would be increased accordingly.

The set of REGs being bundled together is called a REG bundle. In some embodiments, a REG bundle may be composed of contiguous REGs in a PRB. Contiguous REGs means that the REGs are contiguous in frequency and/or time domain. For example, REG bundle #1 may be composed of REG {1, 2, 3, . . . , 6} in the PRB as shown in FIGS. 8A & 8B and REG bundle #2 may be composed of REG {7, 8, 9, . . . , 12} in the PRB as shown in FIGS. 8A & 8B. If the REG bundling size is greater than 3, this REG bundle pattern would be quite different from existing NR specifications because existing NR specifications support a maximum of 3 REGs in a PRB due to the CORESET duration limitation and thus cannot support a REG bundle size greater than 3. In some embodiments, a REG bundle may be composed of interlaced REGs in a PRB. Interlaced REGs means that the REGs are not contiguous in frequency or time domain. For example, REG bundle #1 may be composed of REG {1, 3, 5, . . . , 11} in the PRB as shown in FIGS. 8A & 8B and REG bundle #2 may be composed of REG {2, 4, 6, . . . , 12} in the PRB as shown in FIGS. 8A & 8B. This REG bundle pattern is quite special because existing NR specifications do not support a REG bundle being composed of REGs that are not contiguous in the time or frequency domain.

Candidate CCEs for PDCCH candidates that the UE assumes to monitor and decode may be distributed over multiple PRBs allocated to the TFRS. Same initialization parameters may be used for data scrambling for the PDCCH and DM-RS scrambling sequence. The initialization parameters may be UE-specifically configured.

Given that multiple PDCCHs for different users may use different REGs within the same PRB of the TFRS, that is, the PDCCHs are spatially multiplexed, there is a need to allocate different DM-RS ports of the multiple PDCCHs. In this case, method 700 may further comprises the UE determining a DM-RS port for the UE based on at least one of a UE-specific RRC configuration that indicates the DM-RS port for the UE, or a predefined mapping between REGs used for the PDCCH and DM-RS ports. With the predefined mapping, once it is determined which REGs are used for a PDCCH, the corresponding DM-RS port may be determined and used. If multiple REGs used by a PDCCH map to different DM-RS port based on the predefined mapping, then a rule can be defined to select one DM-RS port, which may also be UE-specific.

FIG. 9 is a flowchart diagram illustrating an example method 900 for wireless communications based on PDCCH in data region according to embodiments disclosed herein. Aspects of the method 900 may be implemented by a network device such as satellite 101, or base station 112 illustrated in FIG. 1 or network device 218 illustrated in FIG. 2 herein and/or more generally in conjunction with any of the computer circuitry, systems, devices, elements, or components shown in the above Figures, among others, as desired. For example, a processor (and/or other hardware) of such a device may be configured to cause the device to perform any combination of the illustrated method elements and/or other method elements.

In wireless communications between a UE and a network device, method 700 performed at the UE side and method 900 performed at the network device side may be implemented in a collaborative way. As features of method 700 have been described in details, features of method 900 that can be shared by both the network side and the UE side can be referred to with a reference to the description of method 700. Below only the features specific to the network side will be discussed.

Method 900 begins, at block 902, with the network device determining configuration information of a TFRS for conveying a PDCCH from a NW device. The TFRS is located in a data region of a subframe. A first part of the configuration information of the TFRS indicates Demodulation Reference Signals (DM-RSs) for the PDCCH are front-loaded. The configuration information of the TFRS corresponds to that described at block 702 of method 700, and thus the features thereof are omitted here.

At block 904, method 900 continues with the network device transmitting the PDCCH in the TFRS based on the determined configuration information of the TFRS. The configuration information of the TFRS describes how the TFRS is configured for carrying the PDCCH. Therefore, upon determination of the configuration information of the TFRS, the NW device would know how to configure the TFRS and then load and transmit the PDCCH in the configured TFRS.

In some embodiments, prior to block 904, method 900 may further comprise the NW device transmitting at least part of the configuration information of the TFRS to the UE. The at least part of the configuration information may be transmitted via at least one of a MIB, a SIB, RRC signaling, or UE specific signaling from the NW device.

Since the PDCCH in the data region may occupies more than one slots and may have repetitions, it is possible for the UE to perform joint channel estimation to improve the channel estimation accuracy. In addition, compared to DM-RSs that are distributed in REGs for carrying DCI of the PDCCH such as 1 DM-RS in every 4 REs, the front-loaded DM-RSs may obtain greater gains from the joint channel estimation. In a joint channel estimation for PDCCH, the UE bundles DM-RSs received for the PDCCH over several slots together for channel estimation. Otherwise, without joint channel estimation, the DM-RSs received from each slot for the PDCCH would be used for channel estimation separately.

To perform the joint channel estimation for PDCCH, the UE should have the capability of joint channel estimation at first and may need to report to the network device of this capability. The UE may report this capability in a UE capability reporting.

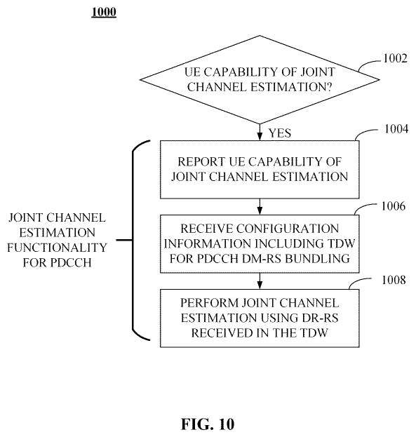

FIG. 10 is a flowchart diagram illustrating an example method 1000 for joint channel estimation for a PDCCH in data region according to embodiments disclosed herein. The PDCCH may be a PDCCH in a TFRS as described above with reference to FIG. 7. Method 1000 may be implemented by a UE such as a UE 102 or UE 104 illustrated in FIG. 1 or UE 202 illustrated in FIG. 2 herein.

At block 1002, the UE may make a determination as to whether it has UE capability of joint channel estimation for the PDCCH. If it is determined that the UE has such a capability, from block 1004 to block 1008, the UE may perform a joint channel estimation functionality for the PDCCH. Specifically, at block 1004, the UE report the UE capability of joint channel estimation for the PDCCH to the network device. At block 1006, the UE receives configuration information for joint channel estimation for the PDCCH from the network device and the configuration information for joint channel estimation including a time domain window (TDW) for bundling the DM-RSs. At block 1008, the UE performs joint channel estimation for the PDCCH using DM-RSs for PDCCH received over slots in the TDW. Based on the estimated channel of the joint estimation result, the UE may decode the PDCCH.

Correspondently, at the network device side, in response to receiving a report of UE capability of joint channel estimation for the PDCCH that is sent at block 1004, the network device transmit the configuration information for joint channel estimation that includes the TDW for bundling the DM-RSs to the UE.

In some embodiments, the TDW in the configuration information for joint channel estimation may be not greater than a maximum duration indicating the maximum number of slots over which UE is able to perform joint channel estimation of PDCCH. The maximum duration may be included in the UE capability of joint channel estimation for the PDCCH. In addition, the TDW may not be greater than a total duration of the repetitions of the PDCCH calculated by a symbol duration of TDRA for the PDCCH multiplied by the repletion number. If the repetition of the PDCCH is broken for some reason (e.g. change of power consistency or phase continuity), the TDW may be restarted and the UE may restart DM-RS bundling for the PDCCH.

In some embodiments, the joint channel estimation functionality for the PDCCH may be jointly enabled or disabled with a joint channel estimation functionality for a PDSCH.

In some embodiments, enabling or disabling of the joint channel estimation functionality for the PDCCH may be signaled via an RRC signaling with explicit or implicit indication. An RRC signaling may be used to directly and explicitly indicate that the joint channel estimation functionality should be enabled or disabled. Alternatively, for example, if the TDRA table entry indicated for the TFRS is not configured with a repetition number, or the configuration of the TFRS indicates that repetition of the PDCCH is not supported, then the joint channel estimation functionality is disabled.

The operations at blocks 1004 to block 1008 may be triggered by the UE in response to detecting a first triggering condition. The first triggering condition indicates that the radio condition for the PDCCH may be non-ideal. In some embodiments, the first triggering condition can be at least one of: a block error rate (BLER) below a threshold, PDCCH Signal to Interference & Noise Ratio (SINR) or Synchronization Signal and Physical Broadcast Channel Block (SSB) Reference Signal Received Power (RSRP) or Channel State Information (CSI) RSRP below a threshold, a number of consecutive PDCCH decoding errors, or UE-specific timing advance (TA) larger than a threshold.

Alternatively or additionally, the operations at blocks 1004 to block 1008 may be triggered by a triggering signal from the NW device. The NW device may transmit the triggering signal to the UE to trigger the UE to perform the joint channel estimation functionality for the PDCCH in response to detecting a second triggering condition. The second triggering condition may indicate that the radio condition for the PDCCH may be non-ideal. In some embodiments, the second triggering condition can be at least one of: a report of UE capability of joint channel estimation for the PDCCH; a UE-specific time offset indicating a slot offset for a Hybrid Automatic Repeat request (HARQ) feedback transmission that is greater than a threshold, or a Channel quality indicator (CQI) reported by the UE that is less than a threshold.

To improve the effectiveness of joint channel estimation for the PDCCH, some restrictions may need to be made on the network device in transmitting the PDCCH over the TDW for DM-RS bundling. Firstly, RB allocation in terms of length and frequency position does not change during the TDW. Secondly, transmission power for the PDCCH over the TDW does not change. Thirdly, Phase continuity between the transmissions is maintained over the TDW.

In various embodiments, some of the elements of the methods (including the methods 400, 600, 700, 900 and 1000) shown may be performed concurrently, in a different order than shown, may be substituted for by other method elements, or may be omitted. Additional elements may also be performed as desired.

Embodiments contemplated herein include an apparatus comprising means to perform one or more elements of the method 400, 700, and 1000. This apparatus may be, for example, an apparatus of a UE (such as a wireless device 202 that is a UE, as described herein).

Embodiments contemplated herein include one or more non-transitory computer-readable media comprising instructions to cause an electronic device, upon execution of the instructions by one or more processors of the electronic device, to perform one or more elements of the method 400, 700, and 1000. This non-transitory computer-readable media may be, for example, a memory of a UE (such as a memory 206 of a wireless device 202 that is a UE, as described herein).

Embodiments contemplated herein include an apparatus comprising logic, modules, or circuitry to perform one or more elements of the method 400, 700, and 1000. This apparatus may be, for example, an apparatus of a UE (such as a wireless device 202 that is a UE, as described herein).

Embodiments contemplated herein include an apparatus comprising: one or more processors and one or more computer-readable media comprising instructions that, when executed by the one or more processors, cause the one or more processors to perform one or more elements of the method 400, 700, and 1000. This apparatus may be, for example, an apparatus of a UE (such as a wireless device 202 that is a UE, as described herein).

Embodiments contemplated herein include a signal as described in or related to one or more elements of the method 400, 700, and 1000.

Embodiments contemplated herein include a computer program or computer program product comprising instructions, wherein execution of the program by a processor is to cause the processor to carry out one or more elements of the method 400, 700, and 1000. The processor may be a processor of a UE (such as a processor(s) 204 of a wireless device 202 that is a UE, as described herein). These instructions may be, for example, located in the processor and/or on a memory of the UE (such as a memory 206 of a wireless device 202 that is a UE, as described herein).

Embodiments contemplated herein include an apparatus comprising means to perform one or more elements of the method 600 and 900. This apparatus may be, for example, an apparatus of a base station (such as a network device 218 that is a base station, as described herein).

Embodiments contemplated herein include one or more non-transitory computer-readable media comprising instructions to cause an electronic device, upon execution of the instructions by one or more processors of the electronic device, to perform one or more elements of the method 600 and 900. This non-transitory computer-readable media may be, for example, a memory of a base station (such as a memory 222 of a network device 218 that is a base station, as described herein).

Embodiments contemplated herein include an apparatus comprising logic, modules, or circuitry to perform one or more elements of the method 600 and 900. This apparatus may be, for example, an apparatus of a base station (such as a network device 218 that is a base station, as described herein).

Embodiments contemplated herein include an apparatus comprising: one or more processors and one or more computer-readable media comprising instructions that, when executed by the one or more processors, cause the one or more processors to perform one or more elements of the method 600 and 900. This apparatus may be, for example, an apparatus of a base station (such as a network device 218 that is a base station, as described herein).

Embodiments contemplated herein include a signal as described in or related to one or more elements of the method 600 and 900.

Embodiments contemplated herein include a computer program or computer program product comprising instructions, wherein execution of the program by a processing element is to cause the processing element to carry out one or more elements of the method 600 and 900. The processor may be a processor of a base station (such as a processor(s) 220 of a network device 218 that is a base station, as described herein). These instructions may be, for example, located in the processor and/or on a memory of the UE (such as a memory 222 of a network device 218 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A user equipment (UE), comprising:
at least one antenna;
at least one radio coupled to the at least one antenna and configured to perform wireless communication using at least one radio access technology; and
one or more processors coupled to the at least one radio and configured to cause the UE to:
determine configuration information of a time-frequency resource set (TFRS), located in a data region of a subframe, for conveying a physical downlink control channel (PDCCH) from a network (NW) device, wherein the configuration information of the TFRS indicates Demodulation Reference Signals (DM-RSs) for the PDCCH are front-loaded; and
monitor for the PDCCH in the TFRS based on the determined configuration information of the TFRS.

2. The UE of claim 1, wherein the PDCCH is at least partially frequency multiplexed with a physical downlink shared channel (PDSCH) in the data region.

3. The UE of claim 1, wherein the one or more processors are further configured to cause the UE to:
receive at least part of the configuration information of the TFRS from the NW device, prior to determining the configuration information of the TFRS, via at least one of:
a master information block (MIB),
a system information block (SIB),
radio resource control (RRC) signaling, or
UE specific signaling from the NW device.

4. The UE of claim 1, wherein the configuration information of the TFRS further comprises, for the PDCCH, a combination of:
a slot offset;
time domain resource allocation (TDRA) information; and
frequency domain resource allocation (FDRA) information.

5. The UE of claim 1, wherein the configuration information of the TFRS further comprises a frame structure of the TFRS that indicates information for resource element group (REG) formation and information for control channel element (CCE)-to-REG mapping for the TFRS.

6. The UE of claim 5, wherein the information for REG formation indicates that at least one REG is formed from resource elements (REs) that are located on a slot within a physical resource block (PRB) in the TFRS in a localized way.

7. (canceled)

8. The UE of claim 5, wherein the information for CCE-to-REG mapping indicates that more than two contiguous REGs in a physical resource block (PRB) in a control resource set (CORESET) constitute a REG bundle to which the UE assumes that a same precoding is applied.

9. The UE of claim 5, wherein the information for CCE-to-REG mapping indicates that a number of interlaced REGs in a physical resource block (PRB) in the TFRS constitute a REG bundle.

10. (canceled)

11. The UE of claim 1, wherein the one or more processors are further configured to cause the UE to:
determine that the UE has a UE capability of joint channel estimation for the PDCCH; and
perform a joint channel estimation functionality for the PDCCH comprising:
report the UE capability of joint channel estimation for the PDCCH to the NW device;
receive configuration information for joint channel estimation for the PDCCH from the NW device, the configuration information for joint channel estimation including a time domain window (TDW) for bundling the DM-RSs; and
perform joint channel estimation for the PDCCH using DM-RSs for PDCCH received over slots in the TDW.

12. The UE of claim 11, wherein the performing of the joint channel estimation functionality is further triggered by the UE in response to detecting a first triggering condition.

13. The UE of claim 11, wherein the performing of the joint channel estimation functionality is further triggered by a triggering signal from the NW device.

14. The UE of claim 11, wherein the joint channel estimation functionality for the PDCCH is jointly enabled or disabled with a joint channel estimation functionality for a physical downlink shared channel (PDSCH).

15. The UE of claim 11, wherein enabling or disabling of the joint channel estimation functionality for the PDCCH is signaled via RRC signaling with an explicit or implicit indication.

16. The UE of claim 1, wherein the one or more processors are further configured to cause the UE to:
determine a DM-RS port for the UE based on at least one of:
a UE-specific RRC configuration that indicates the DM-RS port for the UE, or
a predefined mapping between resource element group (REGs) used for the PDCCH and DM-RS ports.

17. A processor for a user equipment (UE), configured to perform operations comprising:
determining configuration information of a time-frequency resource set (TFRS), located in a data region of a subframe, for conveying a physical downlink control channel (PDCCH) from a network (NW) device, wherein the configuration information of the TFRS indicates Demodulation Reference Signals (DM-RSs) for the PDCCH are front-loaded; and
monitoring for the PDCCH in the TFRS based on the determined configuration information of the TFRS.

18. The processor of claim 17, wherein the configuration information of the TFRS further comprises a frame structure of the TFRS that indicates information for resource element group (REG) formation and information for control channel element (CCE)-to-REG mapping for the TFRS, and wherein the information for REG formation indicates that at least REG is formed from resource elements (REs) that are located on a slot within a physical resource block (PRB) in the TFRS in a distributed way.

19. The processor of claim 18, wherein the information for CCE-to-REG mapping indicates that a number of interlaced REGs in a physical resource block (PRB) in the TFRS constitute a REG bundle.

20. The processor of claim 17, wherein the configuration information of the TFRS further comprises a repetition number indicating a number of times time domain resource allocation for the PDCCH is to be repeated.

21. The processor of claim 17, wherein the operations further comprise:
determining that the UE has a UE capability of joint channel estimation for the PDCCH; and
performing a joint channel estimation functionality for the PDCCH comprising:
reporting the UE capability of joint channel estimation for the PDCCH to the NW device;
receiving configuration information for joint channel estimation for the PDCCH from the NW device, the configuration information for joint channel estimation including a time domain window (TDW) for bundling the DM-RSs; and
performing joint channel estimation for the PDCCH using DM-RSs for PDCCH received over slots in the TDW.

22. A non-transitory computer readable memory medium storing program instructions executable by one or more processors to cause a user equipment (UE) to:
determine configuration information of a time-frequency resource set (TFRS), located in a data region of a subframe, for conveying a physical downlink control channel (PDCCH) from a network (NW) device, wherein the configuration information of the TFRS indicates Demodulation Reference Signals (DM-RSs) for the PDCCH are front-loaded; and
monitor for the PDCCH in the TFRS based on the determined configuration information of the TFRS.

23. (canceled)
